(19) United States
(12) Patent Application Publication
(10) Pub. No.: US 2020/0346293 A1
(43) Pub. Date: Nov. 5, 2020

(54) PERIPHERAL COATING PROCESS OF THE COPPER CONDUCTIVE BAR FOR THE MANUFACTURE OF ANODES, USED IN THE PROCESSES OF ELECTRO-OBTAINING OR ELECTRO-REFINING OF METALS

(71) Applicant: HORACIO RAFART E HIJOS SPA., Santiago (CL)

(72) Inventor: Horacio RAFART MOUTHON, Santiago (CL)

(73) Assignee: HORACIO RAFART E HIJOS SPA., Santiago (CL)

(21) Appl. No.: 16/864,500

(22) Filed: May 1, 2020

(30) Foreign Application Priority Data
May 3, 2019 (CL) 1232-2019

(51) Int. Cl. B23K 1/08; C25F 3/02; C25C 7/02; B23K 1/00; B23K 35/26; C22C 11/08

(52) U.S. Cl. CPC B23K 1/08; C25F 3/02; C25C 7/02; B23K 2101/36; B23K 35/268; C22C 11/08; B23K 1/0016

(57) ABSTRACT

The invention describes the assembly and construction method for anodes used in the electrolytic processes. It is made up of a copper bus bar (1) where the plate shall be inserted (3). It has a rough surface previously milled to form a groove (2), which is, approximately, 0.12 mm thicker than the thickness of the plate; approximately, 19 mm deep. Such copper bus bar (1) is first subject to a process mechanical/chemical or electrochemical process aimed to significantly increase its roughness, between 0.01 mm and 0.5 mm, preferably 0.15 mm, by using mechanical processes, such as sand blasting or grinding, preferably grinding with blasting material made of various metals or using glass balls/copper slag or chemical corrosion by using oxidant chemical agents or anodic electrolytic corrosion aimed to finally improve bonding between the copper bar.

### FIELD OF THE INVENTION

This invention deals with a peripheral coating method/process of the copper bus bar used for manufacturing of anodes. It is used in electrowinning or electro-refining processes for high purity metals, which results in improved features if compared with anodes and manufacturing methods currently known.

### BACKGROUND OF THE INVENTION

It is well known that the use of various processes for electrowinning and electro refining of metals is dated back in 1860. From then on this technology has permanently developed to date, even more with the solvent-extraction technology. The anodes that make up the positive pole of the electrolytic process are made up of a lead-alloy plate with an attached copper bar at the upper end, aimed to conduct the current which is joined to the plate by various joint methods.

Currently, there are three assembly systems that have prevailed in time, for joining the bus bar-body and anode. The first one known as the grooved-bar method, the second one is the method using peripheral coating of the bar. These are the two oldest systems, as they were developed more than three decades ago. The third one uses low fusion welding with grooved bar, aimed to avoid the combing of the plate.

Next there is a brief description of the three aforementioned systems.
a) The grooved-bar method (See FIG. 1 and 2), just as described in the Chilean Patent CL 54299. The copper supporting bar (1) has a groove (2) along its straight portion (R). It is 6 to 12 mm wide and 15 to 25 mm deep, and with a proper length, according to the width of the plate where the laminated plate is introduced (3). The copper supporting bar (1) has been previously coated (4A), (FIG. 3) with the following alloy Pby=52%; Sn=45%; Sb=3%, and the groove (2) has been filled with a high brass alloy (4B). The supporting bar and the lead plate are further (5) FIG. 4, Pb=94%, Sb=6%. Finally, all the head of the anode, i.e. the bus bar, the welding spot and, approximately, 50 mm of the plate below the welding spot is covered by a pure lead electrolytic deposit, up to 0.75-1.0 mm thick.
b) The lead peripheral coating method, (See FIG. 5) just as described in the Chilean Patent CL 54299. The copper supporting bar (8) is covered all over its perimeter with a lead-antimony based alloy (7), preferably with 6% of Sb, with a minimum thickness of 6 mm. The plate (10) and the coating (7) are further welded together (9), with an alloy that is identical to the peripheral coating.
   For all practical purposes manufacturing of anodes with the aforementioned joint processes have had various mechanical/structural flaws along these three decades of use, which could be summarized as follows:
I) A poor-conductivity anode in the peripheral coating system, as the plate is not directly welded to the copper bar, but to its coating. Constant temperature changes of the bus bar during the operation of the cell causes expansion and contraction of the peripheral coating which starts to “come off” and finally is removed from the bus bar. This situation causes significant loss of conductivity, after a few months of operation.
II) With the grooved-bar system, the structural deformation of the anode plates in the electrolytic processes, apart from the corrosion on the lead electrolytic coating of the copper bar, which produces 1. structural deformation and a severe combing problem (concave curvature of the anodes), thus causing short circuits, and 2. contact problems and finally the joint between the bar-plate disappears, due to corrosion.
The grooved-bar type joint system is the one with the best conductivity, but in turn it clearly proves the conceptual flaw of the anode assembly method, which makes this system to cause the severe combing of the anode body. This flaw is quite significant in technical/economic terms for mining area users, as the processes must be ceased in order to change the component. This situation involves a reduction in the productivity of the smelters. The grooved bar system has a significant corrosion on the head of the anode, after one year of operation, as the 0.75 mm thick pure lead electrolytic deposit is destroyed, due to the corrosion of the brass-based welding on the copper bar which acts as a bonding component.
c) The third method is the system described in the Chilean Patent CL42634, which deals with the assembly and construction method for anodes used in the electrolytic processes. It is made up of a copper bus bar with a previously lathed groove that is 0.12 mm thicker than the thickness of the lead plate to be inserted in it. Such copper bus bar is subject to pre-coating by inserting it into an alloy bath at 170° C., preferably with lead with a content between 25% to 27.5%; bismuth between 25% to 27.5% and brass between 45% to 50%. The bar is then placed on the assembly workbench, and then the groove is filled with the same melted alloy, at the same temperature, which is immediately inserted into the lead plate. The copper bar starts to cool, while the lead plate on the joint spot starts to heat. After a while a heat balance is achieved between both components, at 135° C. From that temperature both components start to cool together, both having identical expansion.
When the temperature of the assembly, at the joint spot, has reached 100° C., weld reinforcement is performed on such spot, on both sides. Such weld consists of a filling welding bead inserted between the copper bar and the walls of the lead plate, whose alloy is lead-bismuth up to 55% of bismuth. This system prevents combing of the lead plate, as the stress generated by the differential shrinkage between the copper bar and the lead plate is prevented.

### SUMMARY OF THE INVENTION

The method of this invention proposes a manufacturing technology which technically solves all the negative flaws of the first two aforementioned systems, by proposing a structural anode with functionally improved conductivity, an excellent corrosion rate, no combing, no coming off of the joint between the copper bar and the lead plate, with a high standard bonding between the copper bus bar and the peripheral coating. All these features are obtained by performing significant modifications in the design of the alloys used, because these do not contain brass as its main component, a high corrosion rate component. The copper bar coating of the anode is not lead electrolytically deposited any more, but a melted lead-antimony alloy with a higher thickness. A significant improvement is that this coating is strongly bonded by means of a metallurgical bond between the copper bar (the pre weld coating) and the final peripheral coating of lead/lead-alloy which is improved by generating roughness on the copper bar, in such a way to significantly improve the metallurgical bonding between the copper and the pre-coat of weld, unlike the bond existing in the previously described systems. From a mechanical/metallurgical standpoint the latter are significantly weaker and porous as well, thus causing a more intense corrosion. This new assembly method improves these aspects and conceptually preserves the third system for the bar-body joint with low fusion welding, aimed to avoid combing. With this new/improved method, the copper bus bar (1) is first subject to a roughness increasing method, which improves bonding between the copper bar, a dip weld and a final peripheral coating.

### DESCRIPTION OF THE FIGURES

FIG. 1 describes a full anode.

FIG. 2A describes the copper grooved bar.

FIG. 2B describes the A-A cut of FIG. 2A.

FIG. 3 describes the anode pre-assembly after the groove was filled with weld and inserted into the lead plate.

FIG. 4 describes the anode assembly completed, with its reinforcement weld.

FIG. 5 describes the peripheral coating anode assembly.

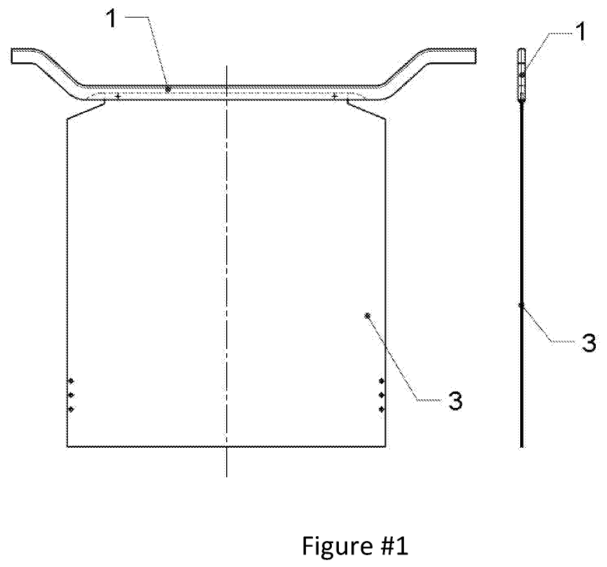

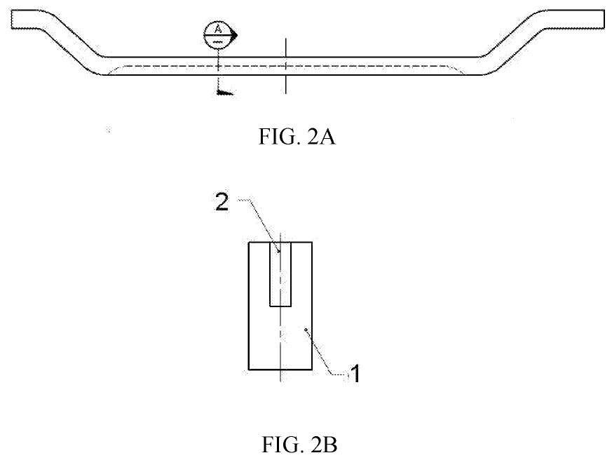

### DESCRIPTION OF THE INVENTION

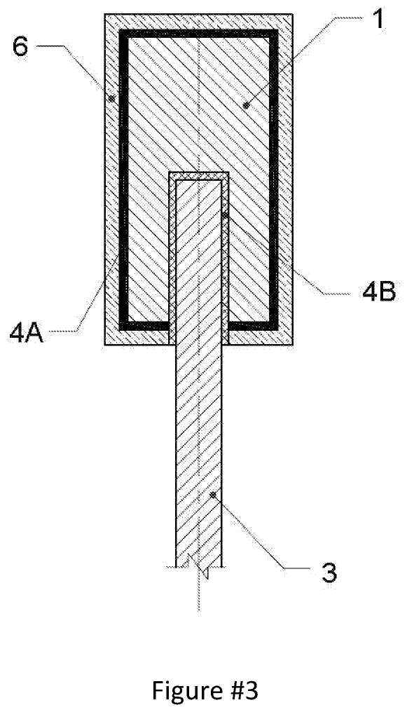

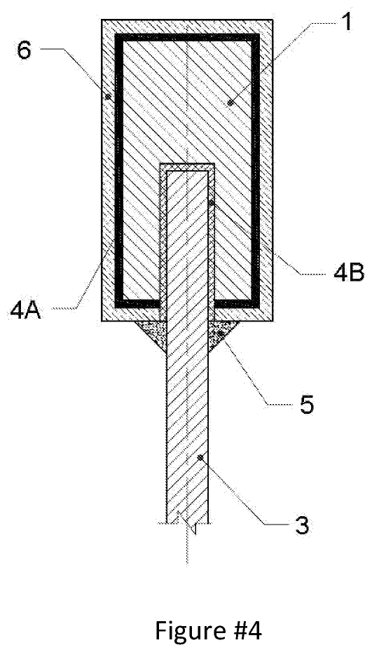

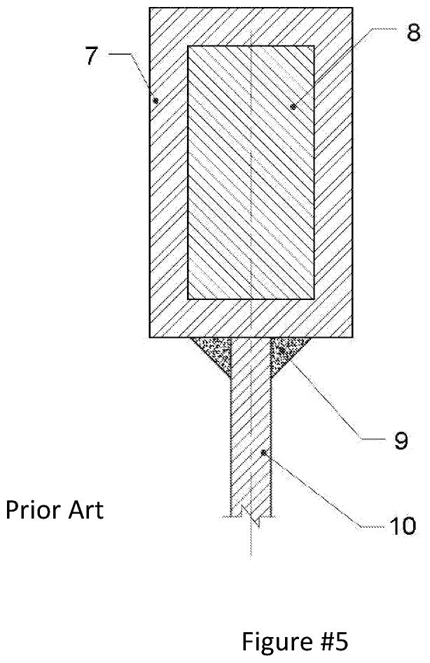

The invention describes the assembly and construction method for anodes used in the electrolytic processes. It is made up of a copper bus bar (1) where the plate shall be inserted (3). It has a rough surface previously milled to form a groove (2), which is, approximately, 0.12 mm thicker than the thickness of the plate; approximately, 19 mm deep. Such copper bus bar (1) is first subject to a process mechanical/chemical or electrochemical process aimed to significantly increase its roughness, between 0.01 mm and 0.5 mm, preferably 0.15 mm, by using mechanical processes, such as sand blasting or grinding, preferably grinding with blasting material made of various metals or using glass balls/copper slag or chemical corrosion by using oxidant chemical agents or anodic electrolytic corrosion aimed to finally improve bonding between the copper bar. Further dip weld, final peripheral coating, dip pre-coating by means of a welding bath (4A) made up of a lead-silver based alloy, with a silver content between 0.1% w/w and 10% w/w, but preferably lead: 97% w/w, silver: 3% w/w, at right temperature (300-350° C.), just as described in FIGS. 3 and 4. Right after, when the bar has just been coated, at 250 to 280° C. it is inserted into a proper model. The peripheral area of the bar is coated (by means of injection or any other similar mechanism) with an lead-antimony alloy, between 0.01 and 11% w/w of Sb preferably 6% w/w, and with a thickness between 0.01 and 10 mm, preferably 1.5 mm, (6), just as described in FIGS. 3 and 4. As an option, the cooper bar can be further coated with a lead-antimony alloy and when still hot it is set on a proper assembly workbench, or left to cool and further reheated in a kiln until getting a temperature between 120° C. and 170° C. and set on an assembly workbench in order to fill the groove (2) with a lead-bismuth melted alloy with having a low fusion point, between 1 to 55% w/w of bismuth (4B) just as described in FIGS. 3 and 4, preferably lead: 50% w/w, bismuth: 50% w/w. The lead-bismuth weld must have such temperature as to allow insertion of the lead plate into the assembly groove while the lead-bismuth weld remains liquid. The lead plate (3) is inserted into the groove of the copper bar, filled with weld (4B). The copper bar (1) starts to cool, while the plate (3)—at the joint spot—starts to heat. After a while heat balance between both bodies is reached, at approximately 135 to 150° C. From that temperature, when both components are expanded they start to cool together. This procedure guarantees no stress generated at the welded spot, which is the cause of combed anodes.

When the assembly temperature at the joint spot has reached, approximately, 100° C., and the weld (4B) has solidified weld reinforcement (5) is made on both sides. Such weld (5) is made up of a weld bead with no filling, between the peripheral coating (6) of the copper bar (1) and the walls of the plate (3). The weld alloy may be a lead-bismuth/lead-antimony alloy, whose lead content is higher than 50% w/w.

1. A method for assembling lead anodes used in the electrolytic processes, which increases corrosion resistance and improves bonding between the copper bar, dip weld into a melted bath and a final peripheral coating of such copper bar comprising the following stages:
a) The copper bus bar is subject to pre-coating by dip welding in a melted bath, at the right temperature (300° C.-350° C.) with an alloy mainly including lead and silver. The silver content is between 0.1% w/w and 10% w/w, preferably 3% w/w;
b) After this pre-coating while the hot copper bar is at a temperature between 250° C. to 280° C., and inserted into a proper mold, the peripheral coating of the copper bar is performed by means of injection or any other similar method with a lead-antimony alloy, between 0.01 and 11% of Sb w/w, preferably 6% w/w, with a thickness between 0.01 and 10 mm, preferably 1.5 mm;
c) Right after injection or pre-heating the copper bar is set onto the assembly workbench to fill the groove with a lead-bismuth alloy, between 1 to 55% w/w of bismuth, preferably 50% w/w, at such temperature to allow insertion of the lead plate, while the lead-bismuth weld remains liquid;
d) Preferably with an identical alloy to that of peripheral coating to weld reinforce the joint spot, between the peripheral coating of the copper bar and the plate, on both sides when the lead-bismuth alloy poured in the groove has solidified. FEATURED, because the copper bar is previously subject to a mechanical/chemical/electrochemical process aimed to increase its roughness, before the pre-coating process of such copper bar.

2. The method, as per claim 1, FEATURED, because the roughness increasing process of the copper bar is performed by mechanical means i.e. sanding or grinding, preferably grinding, with blasting material of various metals, glass balls or copper slag.

3. The method, as per claim 2, FEATURED, because the roughness is achieved by means of chemical corrosion of the surface using oxidant chemical agents.

4. The method, as per claim 3, FEATURED, because the increased roughness process is obtained by means of anodic electrolytic corrosion of the copper bar.

5. The method, as per claims 2, FEATURED, because the final roughness of the copper bar subject to these processes is between 0.01 mm and 0.5 mm, preferably 0.15 mm.

6. A method for assembling lead anodes used in the electrolytic processes, to increase corrosion resistance and improves bonding between a copper bar and lead plate, the copper bar having a groove, comprising:
a) roughening the surface of the copper bar;
b) pre-coating the copper bar by dip welding in a melted bath, at a temperature in the range of 300° C.-350° C. with an alloy including lead and silver, wherein the silver content is between 0.1% w/w and 10% w/w;
c) inserting the copper bar into a mold, while the copper bar is at a temperature between 250° C. to 280° C., and injecting a lead-antimony alloy, between 0.01 and 11% of Sb w/w, and having a thickness between 0.01 and 10 mm;
d) filling the groove with a lead-bismuth alloy between 1 to 55% w/w of bismuth, while maintaining the temperature and inserting the lead plate in the groove while the lead-bismuth weld remains liquid, whereby a joint is formed between the copper bar and the lead plate; and
d) weld reinforcing the joint when the lead-bismuth alloy poured in the groove has solidified.

7. The method of claim 6, wherein the silver content of the pre-coating step is 3% w/w.

8. The method of claim 6, wherein the lead-antimony of the inserting step is 6% w/w.

9. The method of claim 6, wherein the thickness of the inserting step is 1.5 mm.

10. The method of claim 6, wherein the bismuth of the groove filling step is preferably 50% w/w.

11. The method of claim 6, wherein the roughening step is performed prior to the precoating step by one of the group comprising: a mechanical, a chemical and an electrochemical process.
